(19) United States
(12) Patent Application Publication
(10) Pub. No.: US 2026/0119503 A1
(43) Pub. Date: Apr. 30, 2026

(54) VISIBILITY INTO CONNECTIONS ACROSS ORGANIZATIONS

(71) Applicant: Snowflake Inc., Bozeman, MT (US)

(72) Inventors: Amit Dayashankar Gupta, Ridgewood, NJ (US); Manas Mahajan, Pune (IN); Krishnan Parasuraman, Mountain View, CA (US); Biltu Samantha, Bengaluru (IN)

(21) Appl. No.: 18/931,481

(22) Filed: Oct. 30, 2024

(51) Int. Cl. G06F 16/2455; G06F 16/2457; G06F 16/248

(52) U.S. Cl. CPC G06F 16/2456; G06F 16/24556; G06F 16/24578; G06F 16/248

(57) ABSTRACT

The subject technology receives a set of mapped party IDs. The subject technology performs a join operation on the set of mapped party IDs. The subject technology generates a first aggregated list of customer ID and related party CRM ID. The subject technology filters the first aggregated list. The subject technology receives a second aggregated list of customer ID and related party CRM ID. The subject technology determines a metric indicating a sharing propensity of a related party. The subject technology performs union and deduplicate operations on the first and second aggregated lists, and a set of industry influencers. The subject technology performs a lookup operation to determine whether a particular related party shares with a customer ID. The subject technology sorts a third list of recommendations based at least in part on each score of each related party. The subject technology provides for display a sorted list of recommendations.

### TECHNICAL FIELD

Embodiments of the disclosure relate generally to cloud data platforms and, more specifically, to determining collaborative opportunities across various persons, organizations, or entities, and the like.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an aspect of the subject matter in accordance with one embodiment.

FIG. 2 illustrates an example computing environment that includes a cloud data platform, in accordance with some embodiments of the present disclosure.

FIG. 3 illustrates examples of information related to party and related parties that are utilized to determine various attributes, in accordance with embodiments of the subject technology.

FIG. 4 illustrates examples of information related to customers that are utilized to determine various attributes, in accordance with embodiments of the subject technology.

FIG. 5 is a flow diagram illustrating operations of a database system in performing a method, in accordance with some embodiments of the present disclosure.

FIG. 6 illustrates an example of attributes that are extracted during an attribute chunking process as mentioned in at least FIG. 5.

FIG. 7 is a flow diagram illustrating operations of a database system in performing a method, in accordance with some embodiments of the present disclosure.

FIG. 8 is a flow diagram illustrating operations of a database system in performing a method, in accordance with some embodiments of the present disclosure.

FIG. 9 is a flow diagram illustrating operations of a database system in performing a method, in accordance with some embodiments of the present disclosure.

FIG. 10 illustrates an example data processing flow corresponding to a process for determining industry influencers, in accordance with an embodiment of the subject technology.

FIG. 11 illustrates an example data processing flow corresponding to a process for determining industry influencers, in accordance with an embodiment of the subject technology.

FIG. 12 illustrates an example of attributes that are determined using relationships that are provided by a user or account (e.g., via an upload to the data platform, and the like).

FIG. 13 is a flow diagram illustrating operations of a database system in performing a method, in accordance with some embodiments of the present disclosure.

FIG. 14 is a flow diagram illustrating operations of a database system in performing a method, in accordance with some embodiments of the present disclosure.

FIG. 15 illustrates an example of sharing propensity criteria for determining metrics related to sharing propensity, in accordance with an embodiment of the subject technology.

FIG. 16 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

A CRM (Customer Relationship Management) system is primarily used to manage an organization's interactions with current and potential customers. Such a CRM system serves several key purposes:
Storing customer data: The CRM system contains records of customer information, including organization names, website URLs, ticker symbols (e.g., a unique alphanumeric code that identifies a publicly traded company's stock on a particular stock exchange), addresses, and other relevant details
Tracking interactions: It records customer interactions, such as the last activity date, which is used in the ranking process for recommendations
Managing sales opportunities: The CRM system tracks the number of opportunities associated with each customer, which is another factor used in the recommendation process
Supporting sales intelligence: The subject system leverages the CRM data to provide personalized recommendations for potential collaborations and partnerships
Facilitating data sharing: The CRM system helps in verifying if customers can source data products from vendors via data sharing
Enabling targeted marketing: By storing detailed customer information, the CRM system allows for more targeted and personalized marketing efforts
Supporting customer service: The system likely stores information that can be used to provide better customer support and maintain relationships.

In an implementation, the CRM system is integrated with other data sources to provide a comprehensive view of potential business relationships and collaboration opportunities, enhancing its value as a sales intelligence tool.

In some existing systems, automated recommendations for potentially connected organizations were not provided to sellers, and manual efforts were utilized instead to provide such recommendations. For example, such manual efforts can involve using publicly available information and leveraging internal intelligence or consulting internal experts, and potentially miss out on other organizations that collaborate privately and represent hidden opportunities. Such sellers, as referred to herein, are some of the users that interact with the subject system.

In an example, several difficulties in discovering related parties and providing recommendations include data quality and consistency, dynamic business relationships (e.g., where business relationships can change rapidly), industry-specific nuances, scalability, private collaborations (e.g., between parties not included in a public marketplace), and user input variability, among other difficulties. In an example, business relations or relationships can be between vendors (e.g., data providers), trading partners (e.g., suppliers), and customers, among other types of entities, and a reference to a business relation or business relationship can be understood as including any of the aforementioned entities or parties.

Aspects of the present disclosure address the foregoing issues, among others, with a data platform, systems, methods, and devices that enable at least the following:
Getting personalized recommendations for private or marketplace providers in the subject system.
Uploading and looking up partners (e.g., vendors, and the like) and their sharing propensity via the subject system.
Connecting with other sellers, facilitating seller-to-seller connections.
Viewing top industry providers and those used by peers.

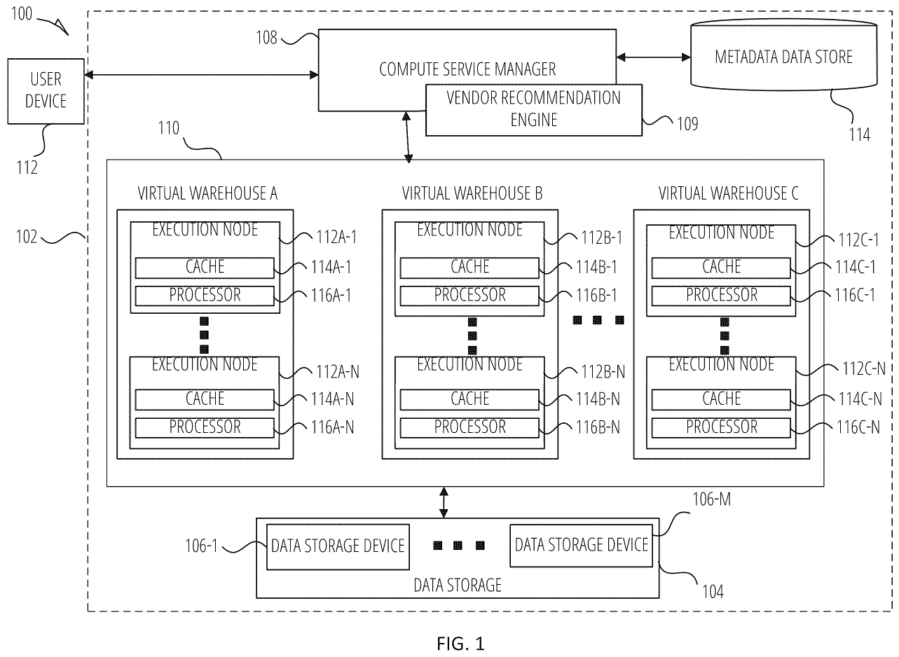

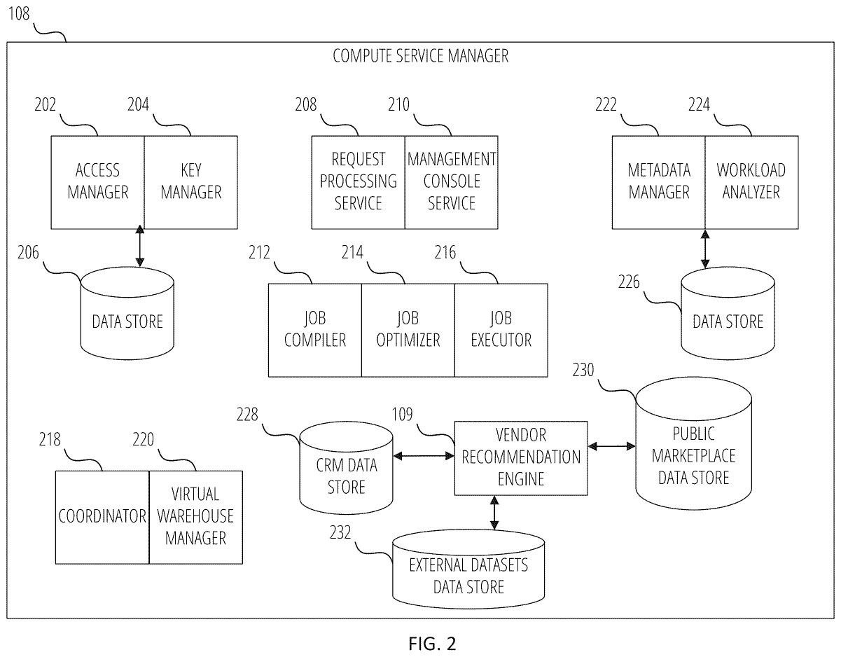

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

As shown, the compute service manager 108 includes a vendor recommendation engine 109 that is responsible for providing recommendations of connections based on different sources, including disparate datasets and other information provided across the subject system. Further details of the operation of the vendor recommendation engine 109 are discussed below.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 2 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 2 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 2. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 2 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 2, the data storage devices 106-1 to 106-M are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 114, execution platform 110, and data storage 104 are shown in FIG. 2 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As shown in FIG. 2, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

In addition, as mentioned above, the compute service manager 108 includes a vendor recommendation engine 109 that is responsible for providing recommendations of connections across various sources, including disparate datasets and other information provided across the subject system. Further details regarding the functionality of the vendor recommendation engine 109, among other components of the subject system, are discussed below.

Moreover, although vendor recommendation engine 109 is shown as being included in compute service manager 108, in other embodiments, vendor recommendation engine 109 can be provided by a given execution node (e.g., execution node 112A-1, and the like).

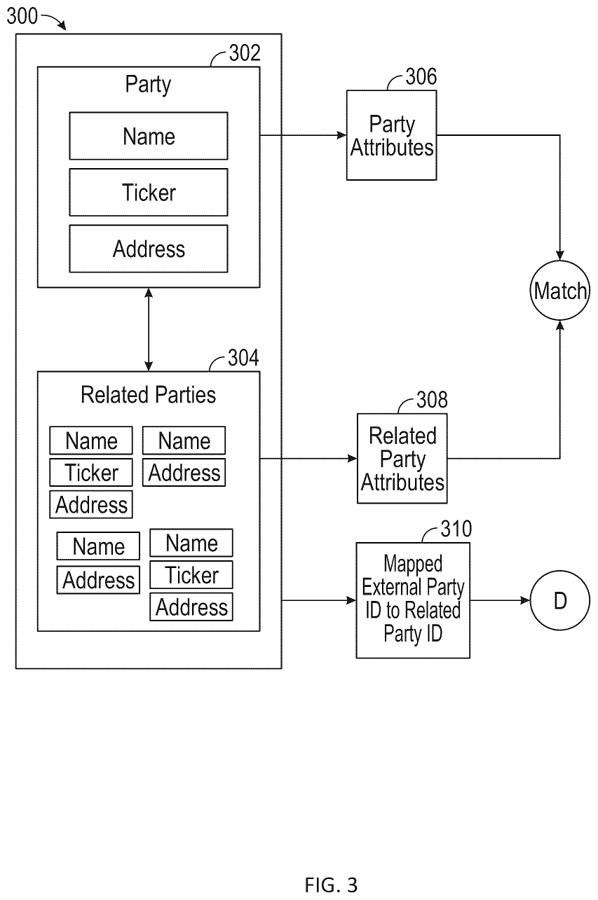

As further illustrated, compute service manager 108 includes CRM data store 228 storing customer information and CRM related information, public marketplace data store 230 storing information related to a listed provider profile and marketplace related information, and external datasets data store 232 storing, for example, external datasets with 1) name, address, ticker, or 2) name, and website URL, which is discussed in more detail in at least FIG. 3. External datasets are sources of information that provide data about organizations outside of an internal CRM system.

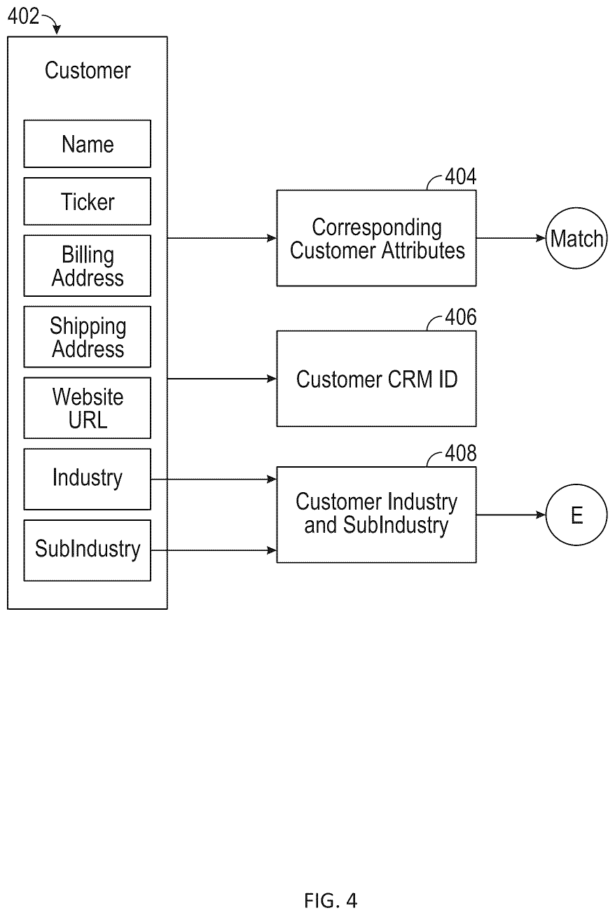

In an example, CRM data store 228 represents data and information stored for an internal CRM system (e.g., provided by data platform 102) where an example of such data and information is discussed at least further in FIG. 4 below. The internal CRM system can store various types of data (e.g., in CRM data store 228) related to customers, partners, and potential collaborators. Such information stored in CRM data store 228 can include one or more of the following:
Customer Attributes: This includes basic information about customers such as company name, website URL, ticker symbol, ticker stock exchange and region, billing and shipping addresses, city, state, and country
Contract Information: This includes details about the customer's contract type (e.g., Capacity or On-Demand)
Activity Data: This tracks the last activity date for each customer or partner
Opportunity Data: Information about the number of opportunities associated with each customer is stored
Marketplace-related Information: For organizations listed on the public marketplace, this stores their marketplace profile name and whether they have a marketplace BD (Business Development) representative assigned
Unique Identifiers: This stores unique identifiers such as Customer IDs, Related Party CRM IDs, and internal company IDs
Industry and Sub-industry Information: This information categorizes customers and partners by their industry and sub-industry
Sharing Propensity Data: For partners or potential collaborators, this stores information related to their propensity to share data, including whether they have existing sharing relationships and the direction of those relationships (e.g., provider to consumer)

A public marketplace refers to a data sharing platform where organizations can publicly list and offer their data products for consumption by other customers. Such a public marketplace serves as a centralized hub for data providers to showcase their offerings and for consumers to discover and access shared data sets. In an example, organizations can create profiles and list their data products on the marketplace (e.g., storing such information in public marketplace data store 230), making them visible to potential consumers.

As discussed further herein, vendor recommendation engine 109 processes information from one or more of the aforementioned data stores to generate recommendations for connections (e.g., recommended related parties, and the like) to a given entity (e.g., customer, and the like).

In a CRM system (e.g., an internal CRM system as discussed herein), a customer can refer to an organization or entity that has a business relationship with a party using the CRM system. In the CRM system, a partner can refer to an organization that collaborates with or provides services to the party using the CRM system.

As discussed further here, recommendations for finding related parties of a particular entity in a given CRM system are generated using a combination of data sources and matching techniques, some of which are listed in the following (e.g., not to be taken as an exhaustive list).
1. Data Sources: The vendor recommendation engine 109 utilizes multiple data sources, including external datasets, internal CRM information, partner uploads, public marketplace information, supply chain information, overlap analysis, and the like.
2. Input Attributes: The vendor recommendation engine 109 uses various input attributes to identify potential “Trading Partners. ” Such attributes include the organization name, website URL, ticker symbol, ticker stock exchange and region, billing and shipping address, city, state, and country.
3. Fuzzy Matching: The vendor recommendation engine 109 employs a Jaro-Winkler similarity (fuzzy match) algorithm to compare these input attributes with customer records in the internal CRM system. This allows for flexibility in matching and can account for slight variations in company names or other details.
4. Identifying industry influencers: The vendor recommendation engine 109 discovers industry influencers through a multi-step process that analyzes various data points related to providers and consumers within specific industries.
5. Union and deduplication: After the initial fuzzy matching and identification of industry influencers, the vendor recommendation engine 109 combines signals (e.g., information related to matched providers and the like) from at least the fuzzy matching and industry influencers and performs a deduplication process to remove superfluous potential recommendation.
6. Ranking: After the union and deduplication, the vendor recommendation engine 109 ranks the records based on a set of metrics or scores.
7. Personalized Recommendations: The vendor recommendation engine 109 generates personalized recommendations based on the matching and ranking process, which are then provided for display (e.g., on a client application, and the like).

This approach allows the CRM system to provide comprehensive and accurate recommendations for finding related parties of a particular entity, leveraging both internal and external data sources while ensuring compliance with privacy policies.

A related party refers to an organization that has a potential business connection or collaboration opportunity with a customer or partner. Related parties are identified through various data sources and matching processes to provide recommendations for potential collaborations or data sharing opportunities.

In more detail, related parties can include:
1. Organizations that share data or collaborate privately through data sharing capabilities of data platform 102.
2. Potential trading partners identified through external datasets and internal CRM system(s).
3. Companies connected through supply chain relationships, as identified by sources including supply chain data.
4. Organizations with overlapping business interests, as determined by information provided by overlap analysis.

The following discussion in FIG. 3 illustrates an example of party information and related party information.

FIG. 3 illustrates examples of information related to party and related parties that are utilized to determine various attributes, in accordance with embodiments of the subject technology.

As illustrated, external datasets 300 includes party information 302 and related parties information 304. In an implementation, external datasets 300 includes 1) information with a name, address, ticker, or 2) information with a name, and website URL. As shown, party information 302 includes a name, ticker, and address. In some implementations, party information 302 can include a particular party ID such as an external party ID that is a unique identifier for a given party associated with party information 302.

As also shown, related parties information 304 includes information such as name, ticker, and address for a given related party, and in some instances a name and address are provided without a ticker. Alternatively or conjunctively, related parties information 304 can also include information with a name, and website URL.

In an implementation, vendor recommendation engine 109 determines (e.g., extracts) party attributes 306 from information stored in external datasets data store 232, and related party attributes 308 from information stored in external datasets data store 232.

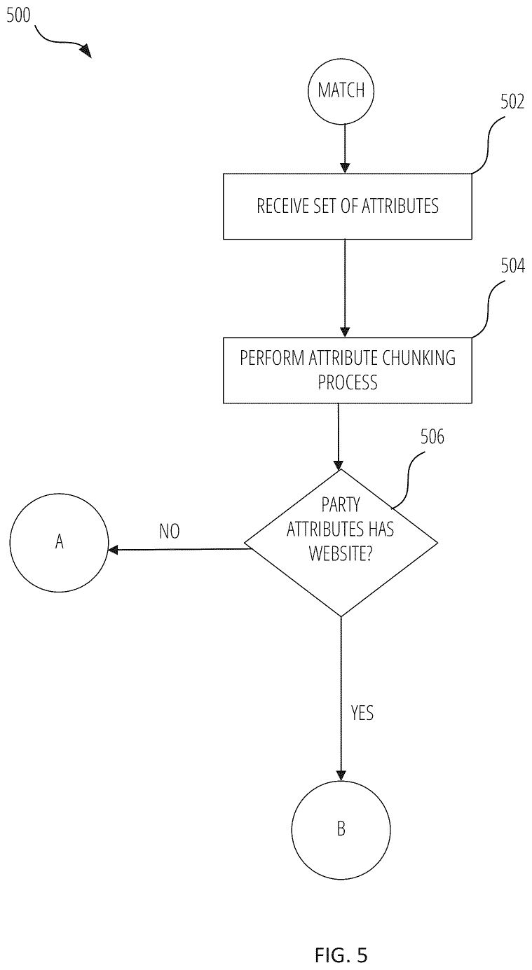

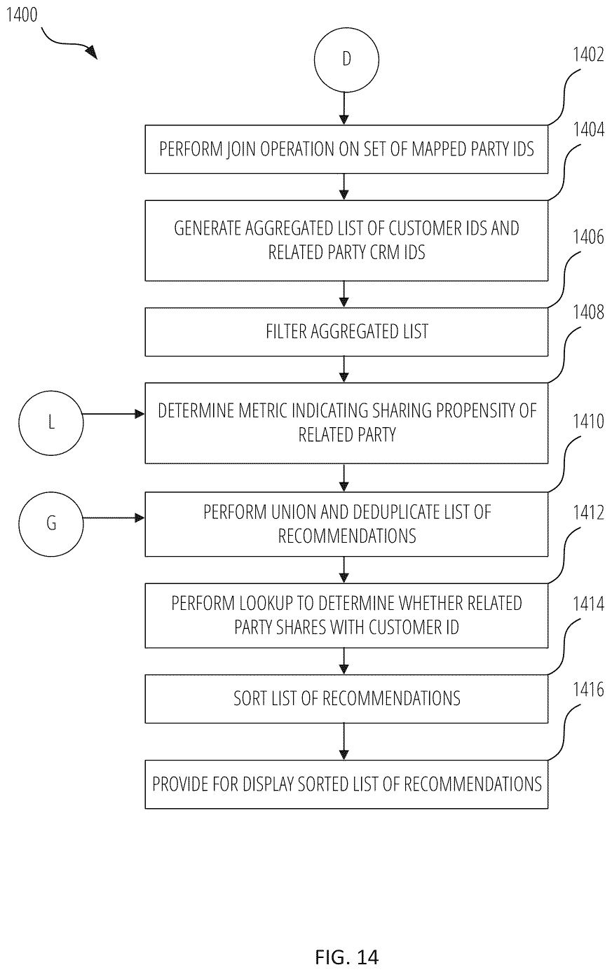

In the example of FIG. 3, party attributes 306 and related party attributes 308 are provided to a matching process, including an attribute chunking process, discussed further herein in FIG. 5. As also shown, vendor recommendation engine 109 performs a mapping to determine a mapped external party ID to related party ID 310, which is forwarded to a subsequent process to determine recommendations as discussed in more detail in FIG. 14.

In an implementation, a related party ID is a unique identifier assigned to organizations that are potential collaborators or data sharing partners for customers of the subject system.

FIG. 4 illustrates examples of information related to customers that are utilized to determine various attributes, in accordance with embodiments of the subject technology.

As illustrated, CRM information 402 can be retrieved (e.g., stored in CRM data store 228). In this example, CRM information 402 includes information including name, ticker, billing address, shipping address, website URL, industry, and subindustry.

As further shown, vendor recommendation engine 109 determines corresponding customer attributes 404, which is utilized during the matching process described in FIG. 5.

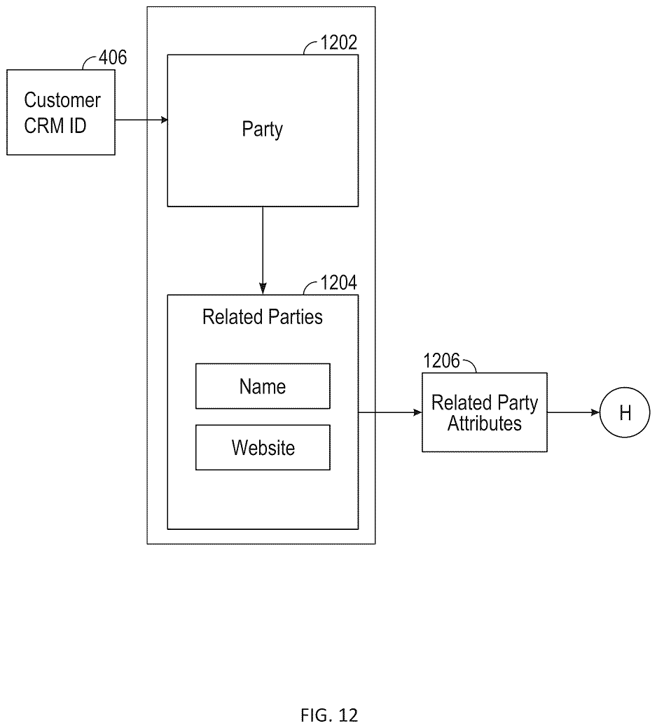

Moreover, vendor recommendation engine 109 determines customer CRM ID 406 based on CRM information 402, and determines customer CRM ID 406 based on CRM information 402. In an example, customer CRM ID 406 is utilized by an internal CRM system (e.g., included in data platform 102) where the internal CRM system stores CRM information 402 (e.g., in CRM data store 228). As discussed further herein, customer CRM ID 406 is utilized when determining related party attributes as discussed further in at least FIG. 12.

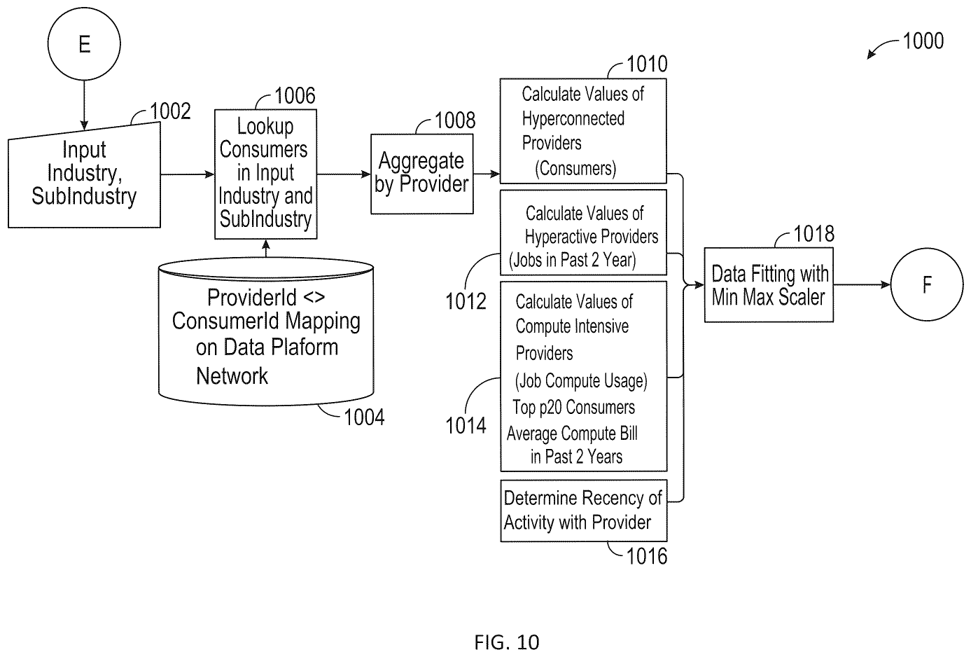

For a separate process, vendor recommendation engine 109 utilizes customer industry and subindustry data 408 based on industry and subindustry information provided in CRM information 402 to determining industry influencers, which is discussed in more detail in FIG. 10.

FIG. 5 is a flow diagram illustrating operations of a database system in performing a method 500, in accordance with some embodiments of the present disclosure. The method 500 may be embodied in computer-readable instructions for execution by one or more hardware components (e.g., one or more processors) such that the operations of the method 500 may be performed by components of data platform 102, such as components of the compute service manager 108 or a node in the execution platform 110. Accordingly, the method 500 is described below, by way of example with reference thereto. However, it shall be appreciated that the method 500 may be deployed on various other hardware configurations and is not intended to be limited to deployment within the data platform 102.

The method 500 is a matching process (as mentioned earlier herein) for determining related parties of a particular party.

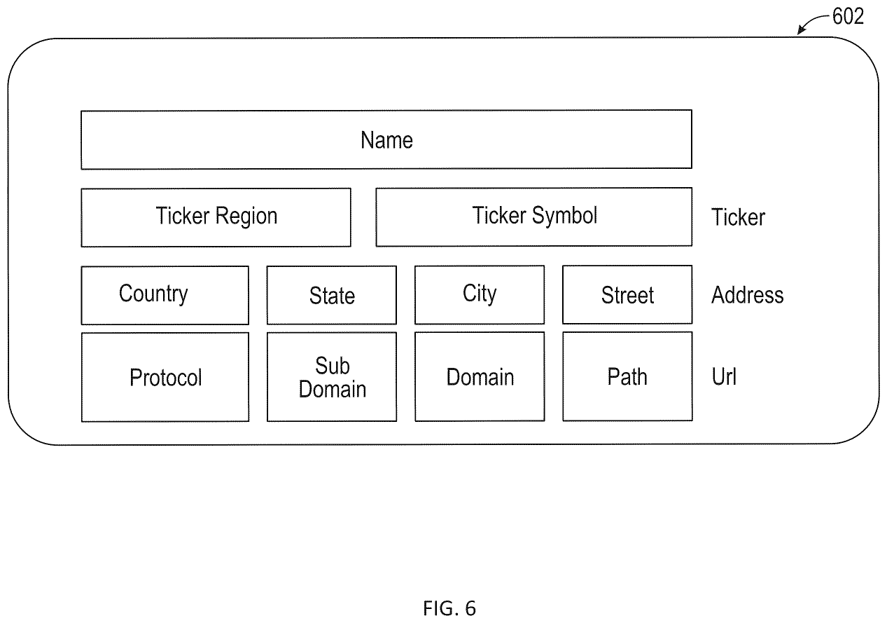

At operation 502, vendor recommendation engine 109 receives a set of attributes including party attributes 306, related party attributes 308, and corresponding customer attributes 404. At operation 504, vendor recommendation engine 109 performs an attribute chunking process. The attribute chunking process can extract various attributes, e.g., a set of party attributes, from the set of attributes (e.g., as discussed more in FIG. 6). In an example, vendor recommendation engine 109 chunks certain attributes such as an address into smaller components (country, state, city, street) to improve matching accuracy.

As mentioned herein, the chunking process in data processing refers to the technique of breaking down large datasets (e.g., including multiple attributes and the like) into smaller, more manageable pieces called “chunks”(e.g., corresponding to individual attributes and the like).

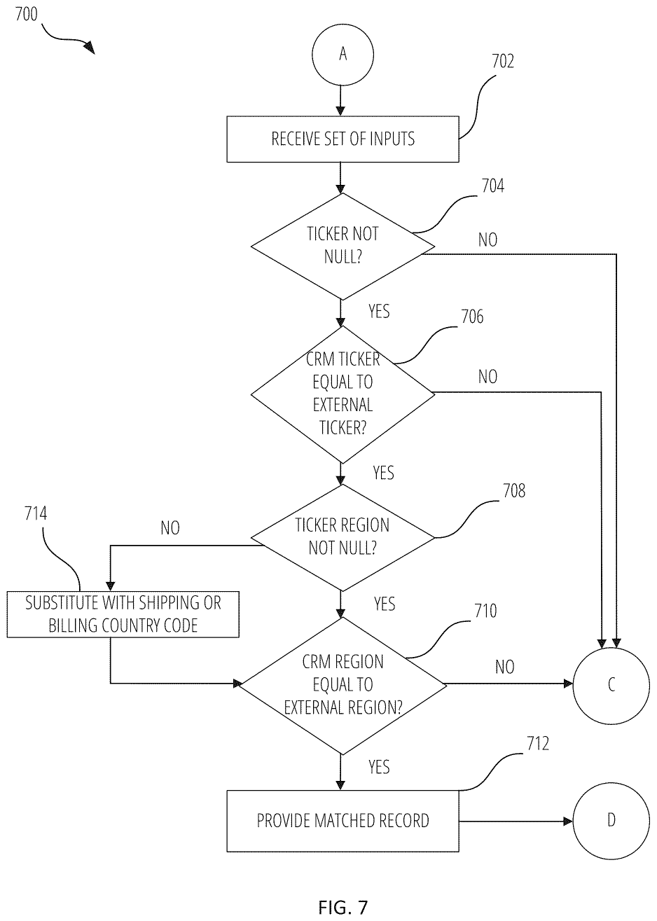

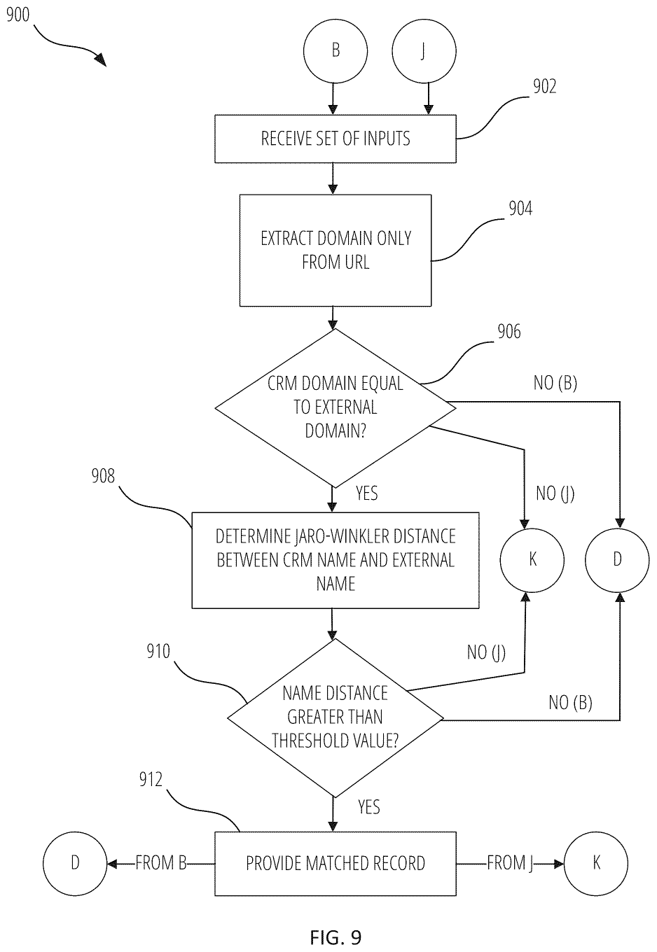

At operation 506, vendor recommendation engine 109 determines whether the party attributes have information related to (e.g., includes) a website. If the set of party attributes include a website then method 500 moves to another method for matching a name of the website described in FIG. 9 that includes additional operations to be performed by vendor recommendation engine 109. Alternatively, if the set of party attributes do not include a website, method 500 continues to another method for matching a name of an address ticker as described below in FIG. 7.

FIG. 6 illustrates an example of attributes that are extracted during an attribute chunking process as mentioned in at least FIG. 5.

As shown, a set of attributes 602 includes various party attributes including a name, ticker region, ticker symbol, county, state, city, street, protocol, sub domain, domain, and path. In an example, vendor recommendation engine 109 determines ticker information based on ticker region and ticker symbol, address information based on country, state, city, and street, and URL information based on protocol, sub domain, domain, and path.

FIG. 7 is a flow diagram illustrating operations of a database system in performing a method 700, in accordance with some embodiments of the present disclosure. The method 700 may be embodied in computer-readable instructions for execution by one or more hardware components (e.g., one or more processors) such that the operations of the method 700 may be performed by components of data platform 102, such as components of the compute service manager 108 or a node in the execution platform 110. Accordingly, the method 700 is described below, by way of example with reference thereto. However, it shall be appreciated that the method 700 may be deployed on various other hardware configurations and is not intended to be limited to deployment within the data platform 102.

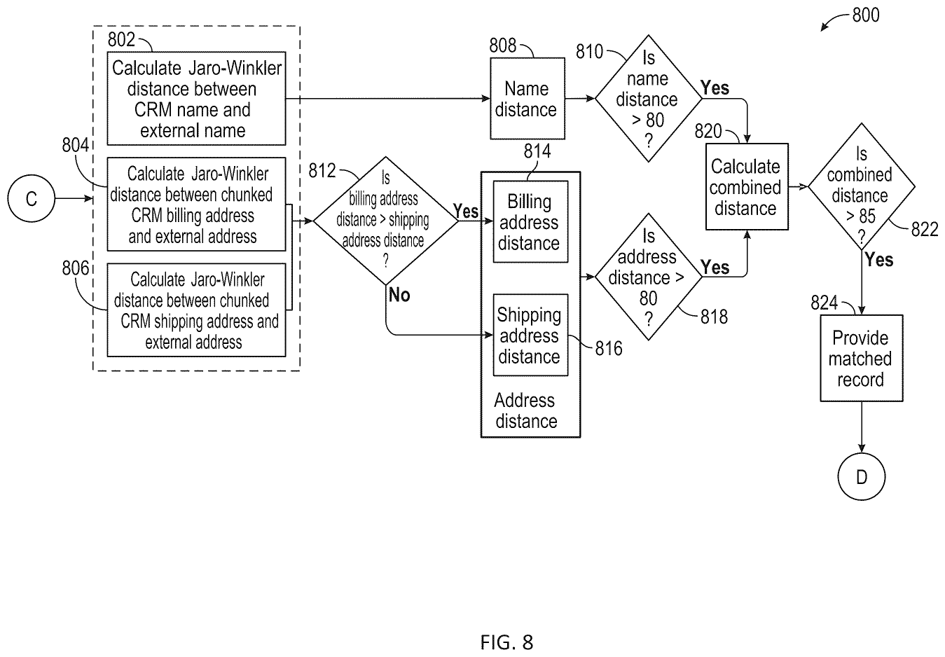

The method 700 is a process for matching an address of a ticker as determined from the method 500 described in FIG. 5. An additional portion of method 700 is described subsequently in FIG. 8 below, where additional operations are performed in some instances as described below in the discussion of FIG. 7. For clarity, FIG. 7 and FIG. 8 are separate figures that, in an embodiment, relate to the same process (e.g., matching an address of a ticker) in which the operations described in FIG. 8 are performed subsequently from operations in FIG. 7.

At operation 702, vendor recommendation engine 109 receives a set of inputs (e.g., provided from the attribute chunking process described in FIG. 5 and CRM information 402). The set of inputs, in this example, includes a first input, including name, ticker, billing, and shipping address, and a second input, including name, ticker, and address.

At operation 704, vendor recommendation engine 109 determines whether the ticker is not null. If the ticker is not null, method 700 continues to operation 706 to determine whether the ticker is equal to an external ticker. Alternatively, if the ticker is null, method 700 moves to an additional portion of the process (e.g., described in FIG. 8) in which various distances are determined between particular attributes from the attribute chunking process described before.

At operation 706, vendor recommendation engine 109 determines whether a CRM ticker (e.g., based on CRM information 402) is equal to an external ticker (e.g., based on party attributes 306). If the CRM ticker is equal to the external ticker, method 700 moves to operation 708. If the CRM ticker is not equal to the external ticker, method 700 moves to an additional portion of the process (e.g., described in FIG. 8) in which various distances are determined between particular attributes from the attribute chunking process described before.

At operation 708, vendor recommendation engine 109 determines whether a ticker region is not null. If the ticker region is not null, method 700 continues to operation 710. When the ticker region is null, method 700 instead moves to operation 714 where vendor recommendation engine 109 substitutes the ticker region with a shipping or billing country code.

At operation 710, vendor recommendation engine 109 determines whether a CRM region is equal to an external region. If the CRM region is equal to the external region, method 700 continues to operation 712. If the CRM region is not equal to the external region, method 700 moves to an additional portion of the process (e.g., described in FIG. 8) in which various distances are determined between particular attributes from the attribute chunking process described before.

At operation 712, vendor recommendation engine 109 provides a matched record. As referred to herein, a matched record links an external organization to its corresponding entry in the internal CRM system (e.g., an internal CRM ID), enabling the data platform 102 and vendor recommendation engine 109 to provide accurate recommendations and insights for potential collaborations and data sharing opportunities. Subsequently, vendor recommendation engine 109 continues to perform additional operations of method 1400 described in FIG. 14 discussed further below.

FIG. 8 is a flow diagram illustrating operations of a database system in performing a method 800, in accordance with some embodiments of the present disclosure. The method 800 may be embodied in computer-readable instructions for execution by one or more hardware components (e.g., one or more processors) such that the operations of method 800 may be performed by components of data platform 102, such as components of the compute service manager 108 or a node in the execution platform 110. Accordingly, method 800 is described below, by way of example with reference thereto. However, it should be appreciated that method 800 may be deployed on various other hardware configurations and is not intended to be limited to deployment within the data platform 102.

FIG. 8 is a continuation of the discussion from FIG. 7, where method 700 has moved to commence to perform a set of operations described in FIG. 8 in response to a particular event(s) that occurred in FIG. 7. As mentioned before, for the sake of clarity, FIG. 7 and FIG. 8 are separate figures. However, it is understood that, in an embodiment, FIG. 7 and FIG. 8 (and their respective methods) may be combined into a single figure and method (e.g., matching the address of the ticker).

At operation 802, vendor recommendation engine 109 calculates a Jaro-Winkler distance between a CRM name and an external name, which produces a name distance discussed in operation 808.

In an embodiment, a Jaro-Winkler distance is a string metric used for measuring the similarity between two strings (e.g., names or words, and the like). The use of Jaro-Winkler distance is considered a form of fuzzy logic in entity matching because it allows for approximate string matching rather than requiring exact matches. This approach enables flexible and tolerant comparisons between input attributes and customer records in the internal CRM system.

Fuzzy logic, in general, deals with reasoning that is approximate rather than fixed and exact. The Jaro-Winkler distance aligns with this concept by:
Measuring the similarity between strings based on the number of matching characters and their positions, rather than requiring exact character-by-character matches
Providing a similarity score between 0 and 1, where 1 indicates an exact match and lower scores represent varying degrees of similarity. This allows for a nuanced assessment of how closely two strings match, rather than a binary yes/no determination.
Giving more weight to matches at the beginning of the strings, which is particularly useful for comparing company names or addresses where the initial parts are often more significant.

As discussed herein, this fuzzy logic approach is applied to various attributes such as organization names, addresses, and other identifying information. By using Jaro-Winkler distance, the subject system can identify potential matches even when there are minor discrepancies in the data, such as typos, formatting differences, or slight variations in how a company's information is recorded across different systems. Consequently, a fuzzy matching process, as described herein, enables the subject system to handle data inconsistencies and improve the accuracy of entity matching, making it a practical application of fuzzy logic in the context of customer relationship management and data integration.

At operation 804, vendor recommendation engine 109 calculates a Jaro-Winkler distance between a chunked CRM billing address and an external address, which produces a billing address distance mentioned below in operation 812.

At operation 806, vendor recommendation engine 109 calculates a Jaro-Winkler distance between a chunked CRM shipping address and an external address, which produces a shipping address distance mentioned below in operation 812.

In an implementation, operation 802, operation 804, and operation 806 may be performed substantially in parallel by vendor recommendation engine 109.

At operation 808, vendor recommendation engine 109 provides the name distance (e.g., from operation 802) between the CRM name and the external name.

At operation 810, vendor recommendation engine 109 determines whether the name distance has a value greater than eighty. Although in the example of FIG. 8, the value of eighty is mentioned in this example, it is appreciated that any appropriate value (e.g., a threshold value) could be utilized and still be within the scope of the subject technology. If the value is not greater than eighty then the method 800 ends (not shown in FIG. 8) and no matched record is provided.

At operation 812, vendor recommendation engine 109 determines whether the billing address distance is greater than the shipping address distance. If the billing address distance is greater than the shipping address distance, vendor recommendation engine 109 provides the billing address distance in operation 814. Alternatively, if the billing address distance is not greater than the shipping address distance, vendor recommendation engine 109 provides the shipping address distance in operation 816.

At operation 818, vendor recommendation engine 109 determines whether the address distance has a value greater than eighty. Although in the example of FIG. 8, the value of eighty is mentioned in this example, it is appreciated that any appropriate value (e.g., a threshold value) could be utilized and still be within the scope of the subject technology. If the value is greater than eighty, method 800 continues to operation 820. If the value is not greater than eighty then the method 800 ends (not shown in FIG. 8) and no matched record is provided.

At operation 820, vendor recommendation engine 109 calculates a combined distance based on the name distance and the address distance.

At operation 822, vendor recommendation engine 109 determines whether the combined distance is greater than a value of eighty-five. If the value is greater than eighty-five, method 800 continues to operation 824. Although in the example of FIG. 8, the value of eighty-five is mentioned in this example, it is appreciated that any appropriate value (e.g., a threshold value) could be utilized and still be within the scope of the subject technology.

At operation 824, vendor recommendation engine 109 provides a matched record. Subsequently, method 800 continues to FIG. 14 describing method 1400.

FIG. 9 is a flow diagram illustrating operations of a database system in performing a method 900, in accordance with some embodiments of the present disclosure. The method 900 may be embodied in computer-readable instructions for execution by one or more hardware components (e.g., one or more processors) such that the operations of method 900 may be performed by components of data platform 102, such as components of the compute service manager 108 or a node in the execution platform 110. Accordingly, method 900 is described below, by way of example with reference thereto. However, it should be appreciated that method 900 may be deployed on various other hardware configurations and is not intended to be limited to deployment within the data platform 102.

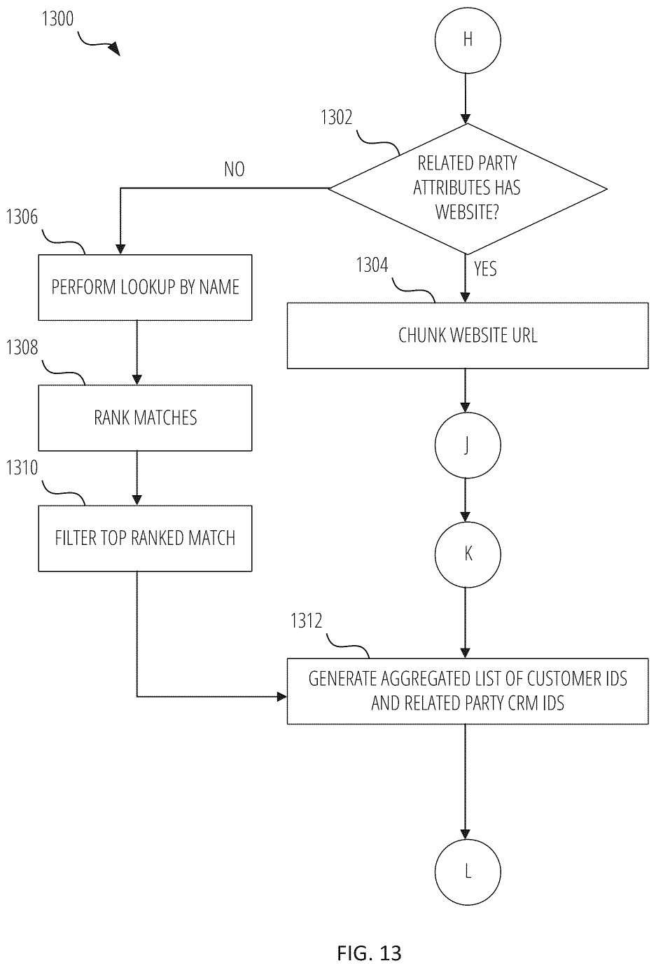

In the example of FIG. 9, method 900 includes operations for matching a name of a website, which is discussed before in FIG. 5 and below in FIG. 13.

At operation 902, vendor recommendation engine 109 receives a set of inputs. In an example, such inputs can include at least a website URL from the set of attributes 602 and CRM information 402 discussed in FIG. 4, FIG. 5, and FIG. 6. Alternatively, the set of inputs can include a website URL as discussed below in FIG. 13 and related party attributes 1206 discussed in FIG. 12.

At operation 904, vendor recommendation engine 109 extracts a domain only from the website URL. A domain, when extracted from a URL, refers to the main part of the website address that identifies the organization or entity associated with that website. For example, if a URL is “https://www.example.com/products”, the extracted domain would be “example.com”.

At operation 906, vendor recommendation engine 109 determines whether a CRM domain is equal to an external domain. If the CRM domain is equal to the external domain, method 900 continues to operation 908. If the CRM domain is not equal to an external domain, subsequently, further operations in FIG. 13 or FIG. 14 are performed depending on whether method 900 was initiated from FIG. 5 (e.g., B then going to D in FIG. 14) or FIG. 13 (e.g., from J then going to K in FIG. 13). In this example, a CRM domain refers to a domain name extracted from the website URL associated with a customer or partner record in the CRM system.

At operation 908, vendor recommendation engine 109 determines a Jaro-Winkler distance between a CRM name (e.g., from CRM information 402) and an external name (e.g., provided from an external dataset(s)).

At operation 910, vendor recommendation engine 109 determines whether the name distance is greater than a threshold value. In an implementation, the threshold value can be a value of eighty. If the name distance is greater than the threshold value, method 900 continues to operation 912. If the name distance is not greater than the threshold value, subsequently, further operations in FIG. 13 or FIG. 14 are performed depending on whether method 900 was initiated from FIG. 5 (e.g., from B then going to D in FIG. 14) or FIG. 13 (e.g., from J then going to K in FIG. 13).

At operation 912, vendor recommendation engine 109 provides a matched record. Subsequently, further operations in FIG. 13 or FIG. 14 are performed depending on whether method 900 was initiated from FIG. 5 (e.g., from B then going to D in FIG. 14) or FIG. 13 (e.g., from J then going to K in FIG. 13).

FIG. 10 illustrates an example data processing flow 1000 corresponding to a process for determining industry influencers, in accordance with an embodiment of the subject technology.

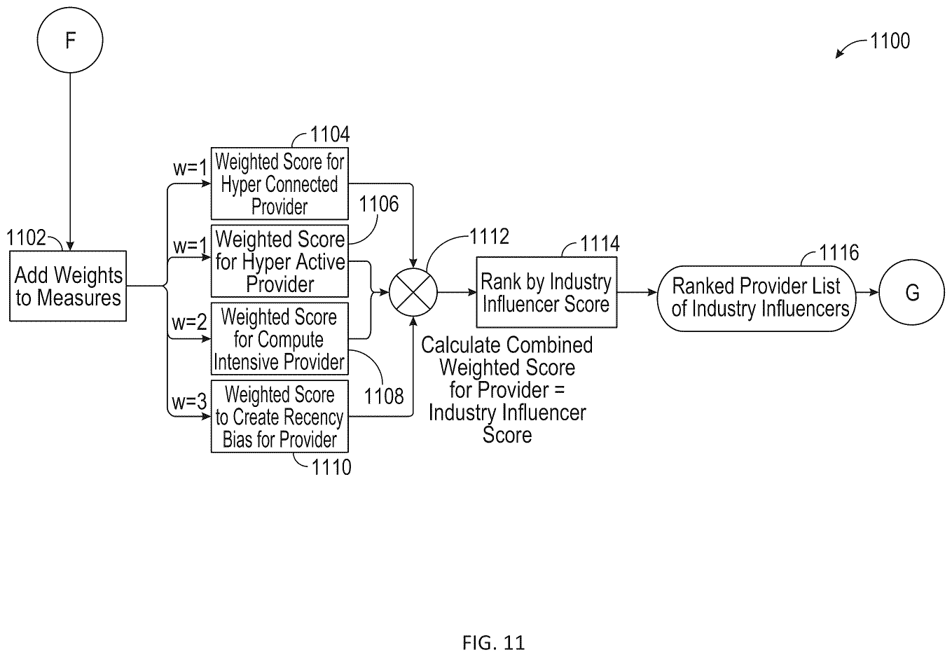

In an example, vendor recommendation engine 109 discovers industry influencers through a multi-step process that analyzes various data points related to providers and consumers within specific industries. FIG. 10 is a first portion of the process for determining industry influencers, and a second portion of the same process is discussed below in FIG. 11.

In an example, industry and subindustry classifications are important categorizations used to organize and analyze data about companies and their relationships. In particular, the industry and subindustry information is used as input for generating personalized recommendations. This allows the subject system to suggest relevant providers or potential collaborators within the same or related industries. By aggregating data by provider within specific industries and subindustries, the subject system can offer more focused and relevant insights to users. The industry and subindustry classifications can contribute to the calculation of weighted scores, which are used to rank providers and determine their relevance to specific customers or use cases. Further, classifications by industry or subindustry help in segmenting the market and understanding the specific needs and trends within different sectors, which is crucial for effective sales and partnership strategies.

The following are example industries and subindustries, which are not considered to be exhaustive and provided for clarity of the following discussion:
Industry: Financial Services
   Subindustries: Investment Banking & Brokerage, Consumer Finance, Commercial & Residential Mortgage Finance
Industry: Technology
   Subindustries: Software, Hardware, Semiconductors
Industry: Retail & Consumer
   Subindustries: Apparel Retail, Home Improvement Retail, Food Retail
Industry: Media & Entertainment
   Subindustries: Advertising, Broadcasting, Interactive Home Entertainment

The data processing flow 1000 includes industry and subindustry inputs 1002 based on industry and subindustry attributes from CRM information 402, which is stored in CRM data store 228.

At operation 1006, vendor recommendation engine 109 performs a lookup of customers, found in industry and subindustry inputs 1002, on provider ID to customer ID mapping data store 1004 to determine information related to a set of providers. In an implementation, provider ID to customer ID mapping data store 1004 stores information, including provider IDs and customer IDs, such that vendor recommendation engine 109 can perform a mapping between a customer ID and a provider ID. A provider, as mentioned herein, shares information (e.g., data sharing) with data platform 102 in which each provider is associated with a provider ID in an implementation, where a provider can refer to an organization or party that offers data products or services through data platform 102. A provider ID can be a unique identifier assigned to an organization that shares data products or services through data platform 102.

In an example, sharing can refer to a process of organizations collaborating and exchanging data products data platform 102 thereby enabling companies or parties to securely share and access data across organizational boundaries, facilitating business collaborations and insights.

A consumer as discussed herein refers to an account, user, or entity that consumes or receives data that is supplied by the provider. A customer ID refers to a unique identifier associated with direct customers or partners, and represents organizations that have a direct business relationship with a given party, such as those using services provided by the party or participating in data sharing activities with the party. In some instances, a customer can be a consumer in the context of the subject system where customers can consume data products shared by other organizations (e.g., providers) on the data platform 102. Moreover, it is appreciated that a provider can be a customer in some instances, and a provider can also be a consumer in some instances.

At operation 1008, vendor recommendation engine 109 aggregates the information by provider (e.g., by provider ID).

At operation 1010, vendor recommendation engine 109 calculates a set of values of a set of hyperconnected providers from the aggregated information. A given hyperconnected provider can be understood as a provider that has the most number of consumers in a particular industry or subindustry. Providers with a higher number of connections within the industry are considered more influential.

At operation 1012, vendor recommendation engine 109 calculates a set of values of a set of hyperactive providers from the aggregated information. A given hyperactive provider can be understood as a provider with jobs within a period of time (e.g., prior two years). A job in this context can be understood as when a party (e.g., consumer) performs a particular action using the data provided to the party from a provider, and this provider is considered a hyperactive provider when this occurs. This metric helps identify providers that are not only well-connected but also actively engaged in the industry.

At operation 1014, vendor recommendation engine 109 calculates a set of values of a set of compute intensive providers from the aggregated information. A given compute intensive provider can be understood as a provider that has a job compute usage that is greater than a particular threshold value of compute utilization, or based on an average compute bill within a period of time (e.g., prior two years). This metric helps identify providers that are processing large amounts of data, which can be an indicator of influence in data-driven industries.

At operation 1016, vendor recommendation engine 109 determines a recency of activity with a provider.

In an embodiment, the outputs (e.g., values) from operation 1010, operation 1012, operation 1014, and operation 1016 are provided in a matrix for additional processing described below.

At operation 1018, vendor recommendation engine 109 performs a data fitting operation with a min-max scaler based on the outputs (e.g., values in a matrix) received from operation 1010, operation 1012, operation 1014, and operation 1016. A min-max scaler is a technique in machine learning, particularly useful when features have vastly different scales, and performs rescaling of the features to a given range, e.g., between 0 and 1, to prevent features with large ranges from dominating a model, and to ensure that all features contribute equally to the model and to improve the convergence of an optimization algorithm(s).

Next, data processing flow 1000 continues to data processing flow 1100 described in FIG. 11 to perform the second portion of the process for determining industry influencers.

FIG. 11 illustrates an example data processing flow 1100 corresponding to a process for determining industry influencers, in accordance with an embodiment of the subject technology.

FIG. 11 is a second portion of the process for determining industry influencers, continuing the data processing flow 1000 of FIG. 10.

At operation 1102, vendor recommendation engine 109 adds weights to measures. In an example, adding weights to measures in data analysis refers to assigning different levels of importance or significance to various metrics or factors within a dataset such as the values in the matrix described before in FIG. 10.

At operation 1104, vendor recommendation engine 109 determines a weighted score for a hyperconnected provider.

At operation 1106, vendor recommendation engine 109 determines a weighted score for a hyperactive provider.

At operation 1108, vendor recommendation engine 109 determines a weighted score for a compute intensive provider.

At operation 1110, vendor recommendation engine 109 determines a weighted score to create recency bias for a provider, ensuring that more recent activity is given higher importance in determining influence.

At operation 1112, vendor recommendation engine 109 calculates a combined weighted score for a provider based on each weighted score from operation 1102, operation 1104, operation 1106, and operation 1108. This allows vendor recommendation engine 109 to balance different aspects of influence. Such a combined weight score is referred to as an industry influencer score herein.

At operation 1114, vendor recommendation engine 109 ranks each provider by industry influencer score (e.g., the combined weight score), with higher scores indicating greater industry influence.

At operation 1116, vendor recommendation engine 109 provides a ranked provider list of industry influencers based on the ranking.

The data processing flow 1100 then continues to the operations described in FIG. 14 below.

FIG. 12 illustrates an example of attributes that are determined using relationships that are provided by a user or account (e.g., via an upload to data platform 102, and the like).

As shown, customer CRM ID 406 is provided and utilized to generate party information 1202 based on information stored in CRM data store 228. In an example, customer CRM ID 406 is utilized by an internal CRM system (e.g., included in data platform 102). A CRM ID in the context of the subject system refers to a unique identifier assigned to a given organization or entity (e.g., customer, party, related party, and the like) within the internal CRM system.

The subject system, in an embodiment, allows users to upload various types of information and relationships for processing. Such information can include some of the following:
Partner Lists: Customers can upload lists of their vendors or partners to check their propensity to share data via data platform 102
Company Names: Users can input company names as part of their partner upload
Website URLs: The subject system accepts website URLs associated with the uploaded partners
Ticker Symbols: Stock ticker symbols can be included in the uploaded information
Billing and Shipping Addresses: Full address information for partners can be uploaded and processed

The uploaded information (e.g., related party information 1204) is utilized to determine related party attributes 1206, which is then processed through one or more matching algorithms, which use fuzzy matching techniques to link the related party attributes 1206 with records in the internal CRM system

The related party attributes 1206 is provided to a method described in FIG. 13.

FIG. 13 is a flow diagram illustrating operations of a database system in performing a method 1300, in accordance with some embodiments of the present disclosure. The method 1300 may be embodied in computer-readable instructions for execution by one or more hardware components (e.g., one or more processors) such that the operations of method 1300 may be performed by components of data platform 102, such as components of the compute service manager 108 or a node in the execution platform 110. Accordingly, method 1300 is described below, by way of example with reference thereto. However, it should be appreciated that method 1300 may be deployed on various other hardware configurations and is not intended to be limited to deployment within the data platform 102.

At operation 1302, vendor recommendation engine 109 determines whether related party attributes 1206 includes an attribute for a website. If related party attributes 1206 includes the attribute for the website, at operation 1304, vendor recommendation engine 109 performs an operation to chunk (e.g., extract) a website URL based on the attribute. Subsequently, method 1300 continues to method 900 described in FIG. 9 before. In the discussion of FIG. 9, method 900 can exit at either operation 906 or operation 910 or operation 912.

Alternatively, if related party attributes 1206 do not have the attribute for the website, vendor recommendation engine 109 continues to operation 1306 to perform a lookup by a name. At operation 1308, vendor recommendation engine 109 ranks a set of matches from the lookup. In an example, vendor recommendation engine 109 uses the following attributes to rank the records and eliminate false negatives:
Contract Type (Capacity/On demand)
Marketplace Profile Name (e.g., for marketplace listings)
Presence of Marketplace BD Name
Number of Opportunities
Last Activity Date

At operation 1310 filters a top ranked match from the set of matches.

At operation 1312, vendor recommendation engine 109 generates an aggregated list of customer IDs and related party CRM IDs.

FIG. 14 is a flow diagram illustrating operations of a database system in performing a method 1400, in accordance with some embodiments of the present disclosure. The method 1400 may be embodied in computer-readable instructions for execution by one or more hardware components (e.g., one or more processors) such that the operations of method 1400 may be performed by components of data platform 102, such as components of the compute service manager 108 or a node in the execution platform 110. Accordingly, method 1400 is described below, by way of example with reference thereto. However, it should be appreciated that method 1400 may be deployed on various other hardware configurations and is not intended to be limited to deployment within the data platform 102.

FIG. 14 illustrates operations that are performed to process different sets of matched records (e.g., various mapped IDs) from different processes discussed before, rank (e.g., sort) the processed matched records, and subsequently provide the ranked results (e.g., as recommendations) for display.

At operation 1402, vendor recommendation engine 109 performs a join operation on a set of mapped party IDs (e.g., combining different sets of information from the set of mapped party IDs). As shown, vendor recommendation engine 109 receives the set of mapped party IDs in which the set of mapped party IDs includes one or more of a mapped external party ID to a related party ID (e.g., from operation(s) performed in FIG. 3), one or more of a mapped external related party ID to an internal CRM ID (e.g., from operation(s) performed in FIG. 5, FIG. 7, and FIG. 8 related to matching name, address, ticker of information from external datasets), or from one or more of a mapped external party ID to internal customer ID (e.g., from operation(s) performed in FIG. 5 and FIG. 9 related to matching name, website of information from external datasets). In an example, a given internal CRM ID is an identifier provided by an (internal to data platform 102) CRM system (e.g., stored in internal CRM data store 228).

At operation 1404, vendor recommendation engine 109 generates an aggregated list of customer IDs and related party CRM IDs.

At operation 1406, vendor recommendation engine 109 filters the aggregated list where the filtering determines that a related party CRM ID is not equal to a customer or a partner. If the related party CRM ID is equal to a customer or a partner, then such a record is filtered.

At operation 1408, vendor recommendation engine 109 determines a metric indicating a related party's sharing propensity. As shown, vendor recommendation engine 109 receives a set of inputs corresponding to an aggregated list of customer IDs and related party CRM IDs from the method 1300 of FIG. 13 (e.g., where a set of matches are determined for relationships uploaded to data platform 102 and the internal CRM system), which is combined with the filtered aggregated list from operation 1406 above. Thus, a set of metrics for sharing propensity are determined based on multiple sources of aggregated list of customer IDs and related party CRM IDs.

At operation 1410, vendor recommendation engine 109 performs a union and deduplicate operations on a list of recommendations (e.g., a recommendation list based on matches from external datasets, internal CRM, and public marketplace). In addition, the list of recommendations includes a ranked list of industry influencers from data processing flow 1100 of FIG. 11 (e.g., where industry influencers are determined). In this manner, these matches from various data sources and matching processes are combined and then deduplicated.

At operation 1412, vendor recommendation engine 109 performs a lookup to determine whether a related party shares with a customer ID. Such a determination enables vendor recommendation engine 109 to increase a score (e.g., potentially resulting in a higher ranking during ranking or sorting) for such a related party that is sharing data with other customers or entities.

At operation 1414, vendor recommendation engine 109 sorts the list of recommendations. In an implementation, the sorting sorts a related party highest if the related party is signaled in multiple sources and is an industry influencer.

In one example, recommendations are sorted based on these combined scores or metrics, with higher scores or metrics indicating a higher ranking. The sorting also takes into account whether a related party is signaled in multiple sources and if they are an industry influencer.

At operation 1416, vendor recommendation engine 109 provides for displaying the sorted list of recommendations.

In an embodiment, the list of recommendations includes the following information:
Business Partner: a name of the recommended partner organization
Industry: an industry sector of the recommended partner
Sharing Propensity: categorized as high, medium, or low, indicating the likelihood of the partner to share data
Sharing Direction: which way is sharing occurring (e.g., inbound or outbound)
Has Paid Listings: indicates whether the partner has paid listings for capacity sharing
Marketplace ID: a unique identifier for the partner in the marketplace
CRM URL: a link to the partner's record in a given CRM system
Last Queried: The date when the partner was last queried or accessed
Reason(s) for Recommendation: An indicator or explanation expressing a reason for the recommendation (e.g., shares established, uploaded by a particular user, and the like)
Marketplace BD: The name of the business development representative associated with the partner

The list can also include visual indicators for sharing propensity (e.g., green for high, yellow for medium, red for low, and the like). Additionally, the recommendation list can be filterable based on sharing propensity in an example. It is appreciated that other information can be provided for display.

Further, although not illustrated in the example of FIG. 14, in an embodiment the vendor recommendation engine 109 can perform a process to remove a set of CRM IDs that are considered sensitive (e.g., not viewable for inclusion in the list of recommendations).

In an embodiment, vendor recommendation engine 109 performs the following operations: receiving a set of mapped party identifiers (IDs), the set of mapped party identifiers being determined using at least a fuzzy matching process applied on information from a set of external datasets, and information from an internal customer relationship management (CRM) system; performing a join operation on the set of mapped party IDs to aggregate the set of mapped party identifiers; generating a first aggregated list of customer IDs and related party CRM IDs based on the join operation, the first aggregated list corresponding to a first list of recommendations; filtering the first aggregated list based on determining whether a related party CRM ID is equal to a customer or partner; receiving a second aggregated list of customer IDs and related party CRM IDs provided by at least a second fuzzy matching process applied on the information from the internal CRM system, and information related to a set of relationships uploaded by a user, the second aggregated list comprising a second list of recommendations; determining, for each related party from the first aggregated list and the second aggregated list, a metric indicating a sharing propensity of a related party associated with the related party CRM ID to adjust a score associated with the related party; performing union and deduplicate operations on the first aggregated list, the second aggregated list, and a set of industry influencers, the performing generating a third list of recommendations; performing, for each related party from the third list of recommendations, a lookup operation to determine whether a particular related party shares with a customer ID to adjust a particular score associated with the particular related party; sorting the third list of recommendations based at least in part on each score of each related party, the sorting providing a sorted list of recommendations; and providing for display the sorted list of recommendations.

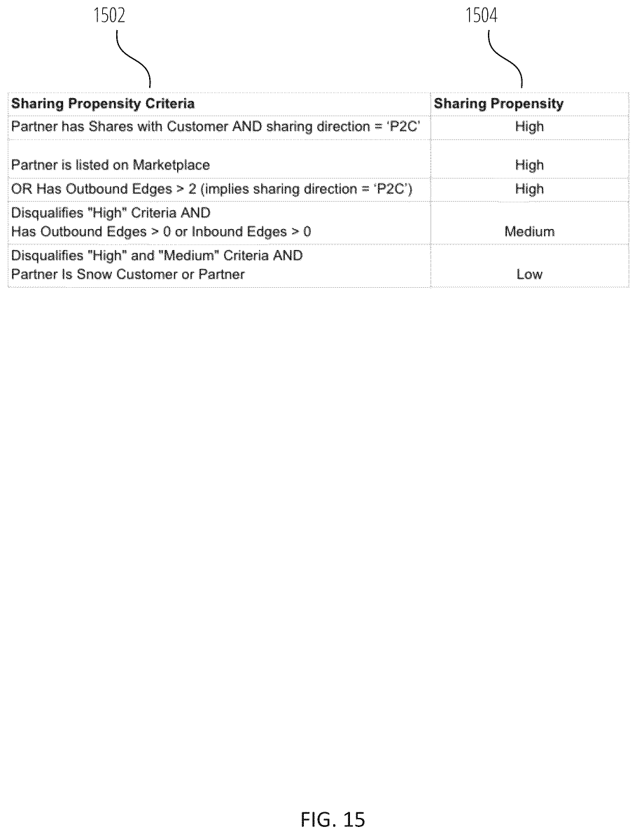

FIG. 15 illustrates an example of sharing propensity criteria for determining metrics related to sharing propensity, in accordance with an embodiment of the subject technology.

In the example of FIG. 15, sharing propensity criteria 1502 includes different criterion including partner has shares with customer and sharing direction is equal to P2C (partner to customer), partner is listed on a marketplace, or has outbound edges greater than 2 (e.g., implying sharing direction is equal to P2C, disqualifies “high” criteria and has outbound edges greater than zero or inbound edges greater than zero, disqualifies “high” and “medium” criteria and partner is customer or partner.

Further, each of sharing propensity criteria 1502 is assigned a particular sharing propensity metric 1504, which can be utilized at least for ranking or sorting of various parties (e.g., as discussed in at least FIG. 14).

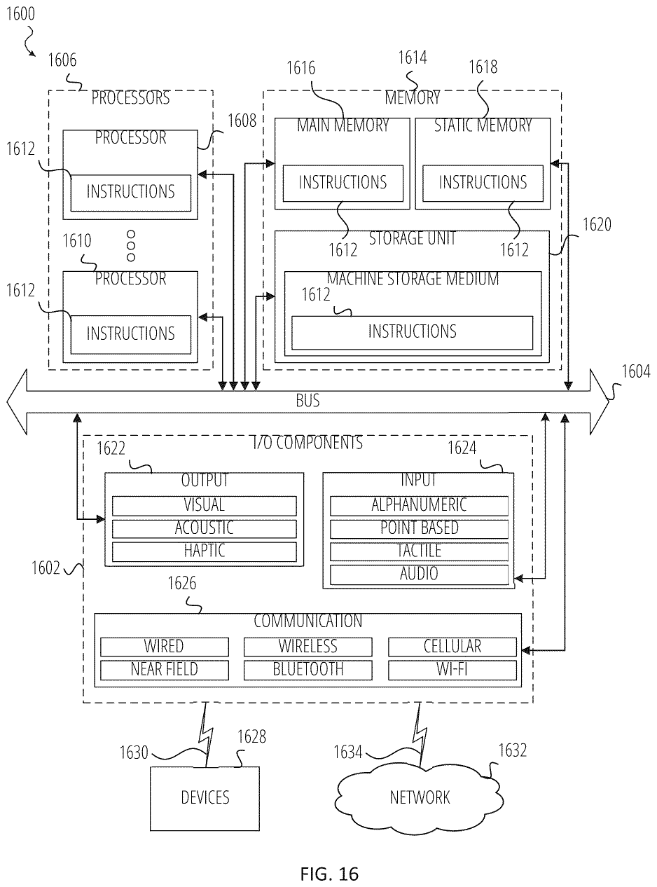

FIG. 16 illustrates a diagrammatic representation of a machine 1600 in the form of a computer system within which a set of instructions may be executed for causing the machine 1600 to perform any one or more of the methodologies discussed herein, according to an example embodiment. Specifically, FIG. 16 shows a diagrammatic representation of the machine 1600 in the example form of a computer system, within which instructions 1612 (e.g., a software, a program, an application, an applet, an app, or other executable code) for causing the machine 1600 to perform any one or more of the methodologies discussed herein may be executed. For example, the instructions 1612 may cause the machine 1600 to execute any one or more operations of the method(s) described herein. As another example, the instructions 1612 may cause the machine 1600 to implement any one or more portions of the functionality illustrated in any one of figures described herein. In this way, the instructions 1612 transform a general, non-programmed machine into a particular machine that is specially configured to carry out any one of the described and illustrated functions of the data platform 102 such as the compute service manager 108 (or a component thereof such as the vendor recommendation engine 109) or an execution node of the execution platform 110.

In some embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1612, sequentially or otherwise, that specify actions to be taken by the machine 1600. Further, while only a single machine 1600 is illustrated, the term “machine” shall also be taken to include a collection of machine 1600 that individually or jointly execute the instructions 1612 to perform any one or more of the methodologies discussed herein.

The machine 1600 includes processors 1606, memory 1614, and i/o components 1602 configured to communicate with each other such as via a bus 1604. In an example embodiment, the processors 1606 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1608 and a processor 1610 that may execute the instructions 1612. The term “processor” is intended to include multi-core processors 1606 that may comprise two or more independent processors (sometimes referred to as “cores”) that may execute instructions 1612 contemporaneously. Although FIG. 16 shows multiple processors 1606, the machine 1600 may include a single processor with a single core, a single processor with multiple cores (e.g., a multi-core processor), multiple processors with a single core, multiple processors with multiple cores, or any combination thereof.

The memory 1614 may include a main memory 1616, a static memory 1618, and a storage unit 1620, all accessible to the processors 1606 such as via the bus 1604. The main memory 1616, the static memory 1618, and the storage unit 1620 store the instructions 1612 embodying any one or more of the methodologies or functions described herein. The instructions 1612 may also reside, completely or partially, within the main memory 1616, within the static memory 1618, within the storage unit 1620, within at least one of the processors 1606 (e.g., within the processor's cache memory), or any suitable combination thereof, during execution thereof by the machine 1600.

The i/o components 1602 include components to receive input, provide output, produce output, transmit information, exchange information, capture measurements, and so on. The specific i/o components 1602 that are included in a particular machine 1600 will depend on the type of machine. For example, portable machines such as mobile phones will likely include a touch input device or other such input mechanisms, while a headless server machine will likely not include such a touch input device. It will be appreciated that the i/o components 1602 may include many other components that are not shown in FIG. 16. The i/o components 1602 are grouped according to functionality merely for simplifying the following discussion and the grouping is in no way limiting. In various example embodiments, the i/o components 1602 may include output components 1622 and input components 1624. The output components 1622 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1624 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 1602 may include communication components 1626 operable to couple the machine 1600 to a network 1632 or devices 1628 via a coupling 1630 and a coupling 1634, respectively. For example, the communication components 1626 may include a network interface component or another suitable device to interface with the network 1632. In further examples, the communication components 1626 may include wired communication components, wireless communication components, cellular communication components, and other communication components to provide communication via other modalities. The devices 1628 may be another machine or any of a wide variety of peripheral devices (e.g., a peripheral device coupled via a universal serial bus (USB)). For example, as noted above, the machine 1600 may correspond to any one of the compute service manager 108, the execution platform 110, and the devices 1628 may include the data store 206 or any other computing device described herein as being in communication with the data platform 102 or the data storage 104.

The various memories (e.g., memory 1614, main memory 1616, static memory 1618 and/or memory of the processors 1606 and/or the storage unit 1620 may store one or more sets of instructions 1612 and data structures (e.g., software) embodying or utilized by any one or more of the methodologies or functions described herein. These instructions 1612, when executed by the processors 1606, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium”discussed below.

In various example embodiments, one or more portions of the network 1632 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1632 or a portion of the network 1632 may include a wireless or cellular network, and the network 1632 may be a Code Division Multiple Access (CDMA) connection, a Global System for Mobile communications (GSM) connection, or another type of cellular or wireless coupling. In this example, the network 1632 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1612 may be transmitted or received over the network 1632 using a transmission medium via a network interface device (e.g., a network interface component included in the communication components 1626) and utilizing any one of a number of well-known transfer protocols (e.g., hypertext transfer protocol (HTTP)). Similarly, the instructions 1612 may be transmitted or received using a transmission medium via the coupling 1630 (e.g., a peer-to-peer coupling) to the devices 1628. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1612 for execution by the machine 1600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of a method may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein. ” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
receiving a set of mapped party identifiers (IDs), the set of mapped party identifiers being determined using at least a matching process applied on information from a set of external datasets, and information from an internal customer relationship management (CRM) system;
performing a join operation on the set of mapped party IDs to aggregate the set of mapped party identifiers;
generating a first aggregated list of customer IDs and related party CRM IDs based on the join operation, the first aggregated list corresponding to a first list of recommendations;
receiving a second aggregated list of customer IDs and related party CRM IDs provided by at least a second matching process applied on the information from the internal CRM system, and information related to a set of relationships uploaded by a user, the second aggregated list comprising a second list of recommendations;
determining, for each related party from the first aggregated list and the second aggregated list, a metric indicating a sharing propensity of a related party associated with the related party CRM ID to adjust a score associated with the related party;
generating a third list of recommendations based on the first aggregated list, the second aggregated list, and a set of industry influencers;
performing, for each related party from the third list of recommendations, a lookup operation to determine whether a particular related party shares with a customer ID to adjust a particular score associated with the particular related party;
sorting the third list of recommendations based at least in part on each score of each related party, the sorting providing a sorted list of recommendations; and
providing for display the sorted list of recommendations.

2. The system of claim 1, wherein the operations further comprise:
filtering the first aggregated list based on determining whether a related party CRM ID is equal to a customer or partner, wherein the information from the set of external datasets comprises a set of party attributes and a set of related party attributes, and the information from the internal CRM system comprises a set of customer attributes corresponding to a party and a related party.

3. The system of claim 1, wherein performing the join operation on the set of mapped party IDs comprises:
performing the join operation on a mapped external party to a related party ID, and a mapped external related party ID to an internal CRM ID, or
performing the join operation on the mapped external party to the related party ID, and a mapped external party ID to an internal customer ID.

4. The system of claim 1, wherein the first list of recommendations comprises a set of customers and a set of related parties.

5. The system of claim 1, wherein the matching process applied on information from the set of external datasets, and information from the internal CRM system is based at least in part on determining that a set of party attributes includes a website, and determining a Jaro-Winkler distance between a name from CRM information from the internal CRM system and an external name from the set of external datasets.

6. The system of claim 1, wherein the matching process applied on information from the set of external datasets, and information from the internal CRM system is based at least in part on determining that a set of party attributes does not include a website, and determining a Jaro-Winkler distance between CRM information from the internal CRM system and external information from the set of external datasets.

7. The system of claim 6, wherein the CRM information from the internal CRM system comprises a CRM name, a chunked CRM billing address, or a chunked CRM billing address.

8. The system of claim 6, wherein the external information from the set of external datasets comprises an external name, or an external address.

9. The system of claim 1, wherein the operations further comprise:
receiving the set of industry influencers, the set of industry influencers being determined by a process for determining the set of industry influencers, the process comprising calculating a first set of values of hyperconnected providers, a second set of values of hyperactivity providers and a third set of values of compute intensive providers, and determining a recency of activity for each provider.

10. The system of claim 9, wherein the first set of values of hyperconnected providers, the second set of values of hyperactivity providers and the third set of values of compute intensive providers, and the recency of activity for each provider undergo data fitting with a min max scaler.

11. A method comprising:
receiving a set of mapped party identifiers (IDs), the set of mapped party identifiers being determined using at least a matching process applied on information from a set of external datasets, and information from an internal customer relationship management (CRM) system;
performing a join operation on the set of mapped party IDs to aggregate the set of mapped party identifiers;
generating a first aggregated list of customer IDs and related party CRM IDs based on the join operation, the first aggregated list corresponding to a first list of recommendations;
receiving a second aggregated list of customer IDs and related party CRM IDs provided by at least a second matching process applied on the information from the internal CRM system, and information related to a set of relationships uploaded by a user, the second aggregated list comprising a second list of recommendations;
determining, for each related party from the first aggregated list and the second aggregated list, a metric indicating a sharing propensity of a related party associated with the related party CRM ID to adjust a score associated with the related party;
generating a third list of recommendations based on the first aggregated list, the second aggregated list, and a set of industry influencers;
performing, for each related party from the third list of recommendations, a lookup operation to determine whether a particular related party shares with a customer ID to adjust a particular score associated with the particular related party;
sorting the third list of recommendations based at least in part on each score of each related party, the sorting providing a sorted list of recommendations; and
providing for display the sorted list of recommendations.

12. The method of claim 11, further comprising:
filtering the first aggregated list based on determining whether a related party CRM ID is equal to a customer or partner, wherein the information from the set of external datasets comprises a set of party attributes and a set of related party attributes, and the information from the internal CRM system comprises a set of customer attributes corresponding to a party and a related party.

13. The method of claim 11, wherein performing the join operation on the set of mapped party IDs comprises:
performing the join operation on a mapped external party to a related party ID, and a mapped external related party ID to an internal CRM ID, or
performing the join operation on the mapped external party to the related party ID, and a mapped external party ID to an internal customer ID.

14. The method of claim 11, wherein the first list of recommendations comprises a set of customers and a set of related parties.

15. The method of claim 11, wherein the matching process applied on information from the set of external datasets, and information from the internal CRM system is based at least in part on determining that a set of party attributes includes a website, and determining a Jaro-Winkler distance between a name from CRM information from the internal CRM system and an external name from the set of external datasets.

16. The method of claim 11, wherein the fuzzy matching process applied on information from the set of external datasets, and information from the internal CRM system is based at least in part on determining that a set of party attributes does not include a website, and determining a Jaro-Winkler distance between CRM information from the internal CRM system and external information from the set of external datasets.

17. The method of claim 16, wherein the CRM information from the internal CRM system comprises a CRM name, a chunked CRM billing address, or a chunked CRM billing address.

18. The method of claim 16, wherein the external information from the set of external datasets comprises an external name, or an external address.

19. The method of claim 11, further comprising:
receiving the set of industry influencers, the set of industry influencers being determined by a process for determining the set of industry influencers, the process comprising calculating a first set of values of hyperconnected providers, a second set of values of hyperactivity providers and a third set of values of compute intensive providers, and determining a recency of activity for each provider.

20. A non-transitory computer-storage medium comprising instructions that, when executed by one or more processors of a machine, configure the machine to perform operations comprising:
receiving a set of mapped party identifiers (IDs), the set of mapped party identifiers being determined using at least a matching process applied on information from a set of external datasets, and information from an internal customer relationship management (CRM) system;
performing a join operation on the set of mapped party IDs to aggregate the set of mapped party identifiers;
generating a first aggregated list of customer IDs and related party CRM IDs based on the join operation, the first aggregated list corresponding to a first list of recommendations;
receiving a second aggregated list of customer IDs and related party CRM IDs provided by at least a second fuzzy matching process applied on the information from the internal CRM system, and information related to a set of relationships uploaded by a user, the second aggregated list comprising a second list of recommendations;
determining, for each related party from the first aggregated list and the second aggregated list, a metric indicating a sharing propensity of a related party associated with the related party CRM ID to adjust a score associated with the related party;
generating a third list of recommendations based on the first aggregated list, the second aggregated list, and a set of industry influencers;
performing, for each related party from the third list of recommendations, a lookup operation to determine whether a particular related party shares with a customer ID to adjust a particular score associated with the particular related party;
sorting the third list of recommendations based at least in part on each score of each related party, the sorting providing a sorted list of recommendations; and
providing for display the sorted list of recommendations.
